(19) United States
(12) Patent Application Publication
(10) Pub. No.: US 2018/0043523 A1
(43) Pub. Date: Feb. 15, 2018

(54) High Voltage Insulating Electric Tool

(71) Applicant: Talent Key Holdings Limited, Hong Kong (HK)

(72) Inventor: Wai Po Sze, Hong Kong (HK)

(21) Appl. No.: 15/486,343

(22) Filed: Apr. 13, 2017

(30) Foreign Application Priority Data
Aug. 12, 2016 (CN) 201620870405.5

(51) Int. Cl. B25G 1/12; B25B 15/02; B25F 1/00

(52) U.S. Cl. CPC B25G 1/12; B25G 1/125; B25F 1/003; B25B 15/02

(57) ABSTRACT

The present invention discloses a high voltage insulating electric tool, comprising insulating handles made of plastic material, and insulating fittings made of ceramic material. The insulating fittings are mounted on the insulating handles in a replaceable manner to directly contact a work piece under service condition and prevent electric shock. The present invention adopts handles made of plastic material and cutting edges made of ceramic so that the entire product cannot bear a risk of breakdown by current in an environment of high voltage. The ceramic cutting edges made of ceramic are replaceable, thereby avoiding the circumstance that the entire metallic electric tool has to be scrapped due to burst, blunting or large clearance of the cutting edges. Further, plastic material and ceramic have desirable chemical stability and strong resistance to acids, alkalis and other chemicals.

### CROSS REFERENCE TO RELATED APPLICATIONS

The present application claims the benefit of Chinese Patent Application No. 201620870405.5 filed on Aug. 12, 2016. All the above are hereby incorporated by reference.

### TECHNICAL FIELD OF THE INVENTION

The present invention relates to an electric tool, more particularly, to an electric tool that can be used in a high voltage environment and bear the features of replaceable fittings and no breakdown by high voltage.

### BACKGROUND OF THE INVENTION

Most operation tools are metallic tools externally covered with plastic as insulation, and their voltage insulation is not higher than 500V in general. After the plastic sheath has been used for a period of time, it may be cracked and damaged due to wear and tear, resulting in failure of insulation.

After metallic cutting edges have been used for a period of time, problems such as serious burst of the cutting edges, blunting of the cutting edges and large clearance between the cutting edges will be emerged. As the cutting edges and the bodies are integrally assembled, the cutting edges cannot be ground again and cutting, peeling and other use functions will be lost after wear.

Electric tools made of metallic material are liable to corrosion in the air. Although surface treatment may be adopted in the later stage to resist corrosion, the cost will be increased remarkably.

Metallic electric tools are seldom used on an occasion of high/low frequency circuit, mainly for preventing the generated static electricity from breaking down circuit elements. The oxidized electric tools are even more unsuitable for this occasion. In addition, if electric tools completely made of plastic are used on an occasion of high/low frequency circuit, they will be worn fast. Frequent replacement of the tools will lead to increase of maintenance cost.

Therefore, based on the defects of prior art and people's need for use of insulating tools in a high voltage environment, it is in urgent need of a new type of electric tool, which is not only replaceable after wear but also usable in an environment of high voltage, without worries of breakdown.

### SUMMARY OF THE INVENTION

The object of the present invention is to solve the foregoing technical problems and provide a novel electric tool, which can be not only replaceable after wear but also usable in an environment of high voltage.

According to the present invention, the present invention adopts the following technical solution to realize the foregoing object:

A high voltage insulating electric tool, comprising:

an insulating handle made of plastic material; and

an insulating fitting made of ceramic material and mounted on the insulating handle in a replaceable manner to directly contact a work piece under service condition and prevent electric shock.

Preferably, the plastic material is selected from the group consisting of PE, PP, PVC or PET. Of course, the plastic material may also be any other insulating plastic material. In an embodiment, the ceramic material mainly includes zirconium oxide.

In an embodiment of the high voltage insulating electric tool provided by the present invention, the high voltage insulating electric tool is insulating pliers, of which the insulating handle comprises a first plier arm and a second plier arm. Further, the insulating fitting includes two cutting edges made of ceramic material, which is mounted to one end of the first plier arm and one end of the second plier arm via fixing members in a replaceable manner. In an embodiment, the fixing members are screws.

In an alternative embodiment of the high voltage insulating electric tool provided by the present invention, the high voltage insulating electric tool is an insulating screwdriver. The insulating handle of the insulating screwdriver is a hand grip, and the insulating fitting of the insulating screwdriver is a bit; and wherein the insulating handle and the insulating fitting are engaged together in a plug-in manner.

Apparently, the resistivity of the plastic material employed in the new technology of the present invention is more than 10⁸ Ω·cm, while the resistivity of ceramic is more than 10¹⁵ Ω·cm. Moreover, plastic material and ceramic almost are not affected by temperature, humidity and frequency. When the handles made of plastic material and the cutting edges made of ceramic (for example, zirconium oxide is the main material) work in an environment of high voltage, they will not be broken down by current.

Although the hardness of tool steel is HRC58-62 after heat treatment, the cutting edges made of ceramic can be replaceable while their hardness reaches HRA88-90. What is more, the blunting cycle of ceramic cutting edges is much longer than that of metallic cutting edges, and ceramic cutting edges are replaceable, thereby avoiding the circumstance that the entire metallic electric tool has to be scrapped due to burst, blunting and large clearance of the cutting edges.

Furthermore, plastic material and ceramic have desirable chemical stability and strong resistance to acids, alkalis and other chemicals and possess the features of antifriction, wear resistance and self-lubrication, which can completely avoid the problems of rusting and static current during use.

### BRIEF DESCRIPTION OF THE DRAWINGS

Below the high voltage insulating electric tool provided by the present invention will be described in details by referring to the accompanying drawings, in which:

FIG. 1 is a schematic view of the high voltage insulating electric tool according to one embodiment of the present invention;

FIG. 2 is an exploded view of the electric tool shown in FIG. 1;

FIG. 3 is a schematic view of the high voltage insulating electric tool according to another embodiment of the present invention; and

FIG. 4 is an exploded view of the electric tool shown in FIG. 3.

### DETAILED DESCRIPTION OF THE INVENTION

The term “insulating electric tools” herein includes all relevant electric tools used during operation in high-low voltage and high-low frequency environment. For example, the relevant electric tools include insulating pliers, insulating screwdrivers and other electric tools.

The high voltage insulating electric tool of the present invention comprises an insulating handle made of plastic material and an insulating fitting made of ceramic material. The insulating fitting is mounted on the insulating handle in a replaceable manner to directly contact a work piece under service condition and prevent the risk of electric shock.

Preferably, the plastic material is selected form the group consisting of PE, PP, PVC or PET. Obviously, those skilled in the art should understand that the plastic material may also be any other insulating plastic materials. In an embodiment of the invention, the ceramic material mainly includes zirconium oxide.

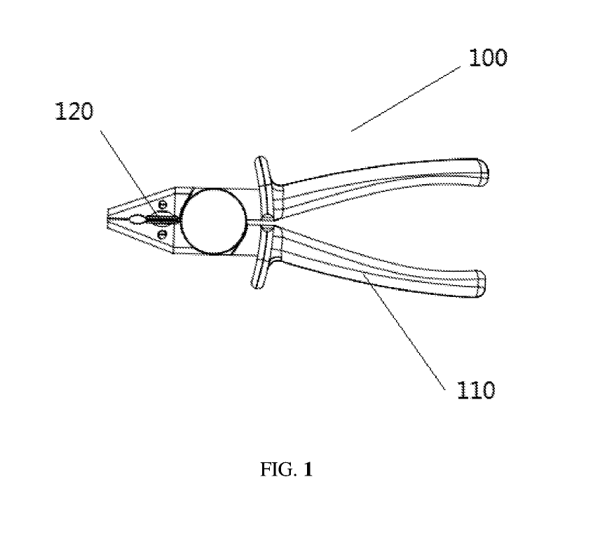

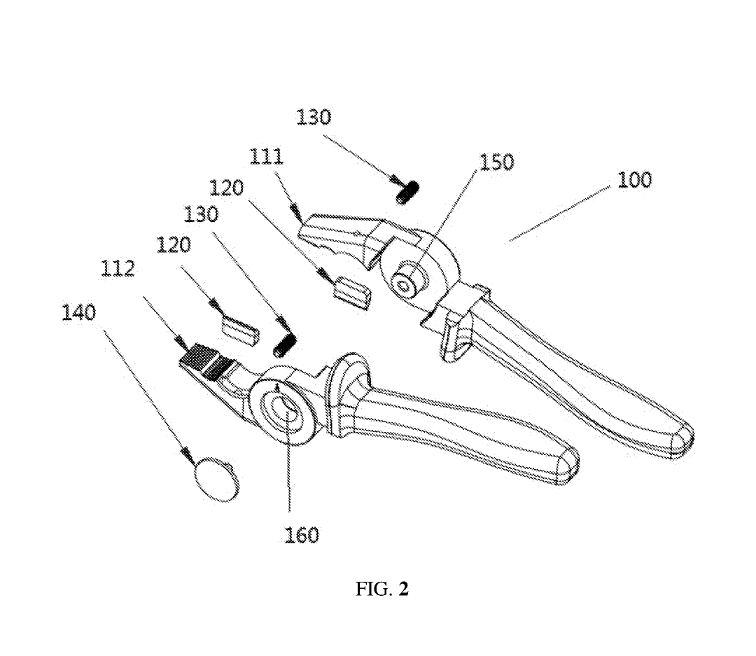

As shown in FIG. 1 and FIG. 2, in an embodiment of the high voltage insulating electric tool of the present invention, the high voltage insulating electric tool is insulating pliers 100 comprising insulating handles 110. The insulating handles 110 comprise a first plier arm 111 and a second plier arm 112. A protrusion 150 is disposed on the first plier arm 111, a through-hole 160 is disposed on the second plier arm 112, and the first plier arm 111 and the second plier arm 112 may be connected in a moveable manner through the protrusion 150 and the through-hole 160.

The insulating fitting includes two cutting edges 120 which are made of ceramic material. Through fixed members, the cutting edges 120 are mounted to one end of the first plier arm 111 and one end of the second plier arm 112 in a replaceable manner. In an embodiment of the invention, the fixing members are screws 130. Use of screws 130 may lead to generation of perfect fixing effects. Further, the cutting edges 120 can be easily replaced when the cutting edges 120 are damaged or blunted.

Moreover, lock nuts 140 made of plastic are disposed on the connectors of the first plier arm 111 and the second plier arm 112 to enhance stability and improve the appearance of the product.

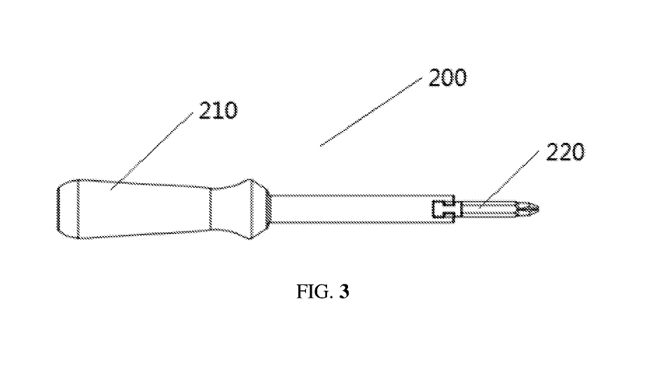

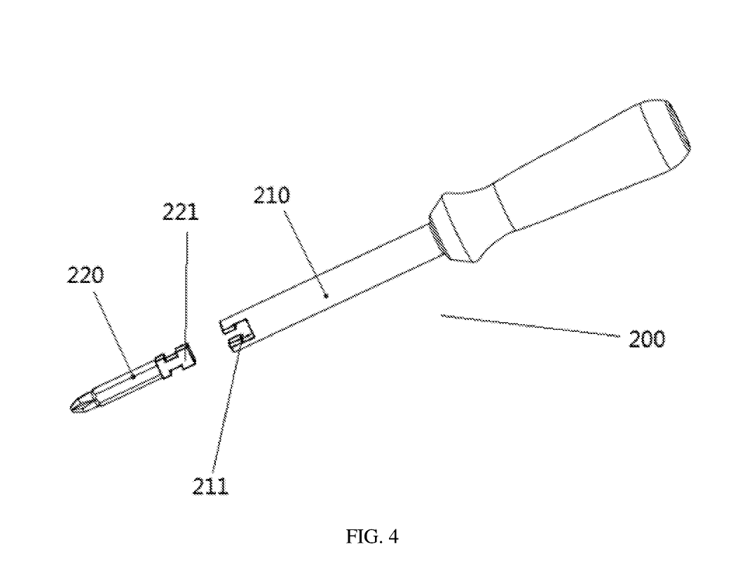

As shown in FIG. 3 and FIG. 4, according to an alternative embodiment of the present invention, the high voltage insulating electric tool is an insulating screwdriver 200. The insulating handle of the insulating screwdriver 200 is a hand grip 210 made of plastic material, the insulating fitting of the insulating screwdriver 200 is a bit 220 made of ceramic material, and the hand grip 210 and the bit 220 are engaged together in a plug-in manner. In other words, a hole 211 is disposed at one end of the hand grip 210, and one end of the bit 220 is shaped as a “H” 221, by which the end shaped as “H” is inserted into the hole 211, and the bit 220 is thus secured onto the hand grip 210 readily.

The handle of the present invention is made of plastic material and the cutting edges are made of ceramic in which zirconium oxide is the main material so that the problem of breakdown of the product by current in an environment of high voltage can be easily avoided. Although the hardness of tool steel is HRC58-62 after heat treatment, the cutting edges made of ceramic can be replaceable while their hardness reaches HRA88-90. What is more, the blunting cycle of ceramic cutting edges is much longer than that of metallic cutting edges, and ceramic cutting edges are replaceable, thereby avoiding the circumstance that the entire metallic electric tool has to be scrapped due to burst, blunting and large clearance of the cutting edges.

In addition, plastic material and ceramic have desirable chemical stability and strong resistance to acids, alkalis and other chemicals and possess the features of antifriction, wear resistance and self-lubrication, which can completely avoid the problems of rusting and static current during use.

The present invention is set forth with reference to various embodiments and accompanying drawings. It should be understood that those skilled in the art may make various changes and equivalents to the present invention without departing from the spirit and principle of the present invention upon a reading of the specification and study of the drawings. For example, the technical features shown or described in an embodiment may be used in an alternative embodiment to obtain a further embodiment. It should be appreciated that all the changes and equivalents according to the present invention shall be fallen into the protective scope of appended claims hereto.

What is claimed is:

1. A high voltage insulating electric tool comprising:
an insulating handle made of plastic material; and
an insulating fitting made of ceramic material and mounted on the insulating handle in a replaceable manner to directly contact a work piece under service condition and prevent electric shock.

2. The high voltage insulating electric tool according to claim 1, wherein the high voltage insulating electric tool is insulating pliers, of which the insulating handle comprises a first plier arm and a second plier arm.

3. The high voltage insulating electric tool according to claim 2, wherein the insulating fitting includes two cutting edges made of ceramic material, which are mounted to one end of the first plier arm and one end of the second plier arm via fixing members in a replaceable manner.

4. The high voltage insulating electric tool according to claim 3, wherein the fixing members are screws.

5. The high voltage insulating electric tool according to claim 1, wherein the high voltage insulating electric tool is an insulating screwdriver.

6. The high voltage insulating electric tool according to claim 5, wherein the insulating handle of the insulating screwdriver is a hand grip, and the insulating fitting of the insulating screwdriver is a bit;
and wherein the insulating handle and the insulating fitting are engaged together in a plug-in manner.

7. The high voltage insulating electric tool according to claim 1, wherein the plastic material is selected from the group consisting of PE, PP, PVC or PET.

8. The high voltage insulating electric tool according to claim 1, wherein the ceramic material includes zirconium oxide.
